(19) United States
(12) Patent Application Publication
(10) Pub. No.: US 2003/0158770 A1
(43) Pub. Date: Aug. 21, 2003

(54) Method and system for assigning and reporting preventative maintenance workorders

(75) Inventors: Leif Carlson, Vancouver, WA (US); Tony Feliciano, Vancouver, WA (US); Michael M. Robinson, Vancouver, WA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: SEH America, Inc.

(21) Appl. No.: 10/079,996

(22) Filed: Feb. 19, 2002

(51) Int. Cl. G06F 17/60

(52) U.S. Cl. 705/9

(57) ABSTRACT

A method and system for assigning and reporting a plurality of preventative maintenance workorders is generally implemented by a computer system, including a computer network, interfaces, and a database. The method and system permit assigning and reporting preventative maintenance workorders via an electronic mailbox associated with each interface. Maintenance data associated with the preventative maintenance procedure is recorded on a checksheet and stored in a database. If maintenance data exceeds an out of specification tolerance, the method and system include automatically notifying responsible personnel according to different levels of criticality. The method and system also permit creation of one of a plurality of workorders in a database.

### BACKGROUND OF THE INVENTION

The present invention relates to preventative maintenance of facilities' systems and equipment, and, more particularly, to a method and system for assigning and reporting preventative maintenance workorders associated with facilities' systems and equipment including the creation of a plurality of workorders with periodic scheduling requirements.

### FIELD OF THE INVENTION

Facilities' systems and equipment typically require monitoring and evaluation of operating parameters to ensure system reliability and to maintain production efficiency. Preventative maintenance is included in the monitoring and evaluation of facilities' systems and equipment. Preventative maintenance generally includes diagnostic procedures, measurement of operating parameters, inspection of parts for wear, replacement of parts, and preservation procedures such as cleaning and lubrication. Often, preventative maintenance workorders require that data sheets be completed listing the various operating parameters, status of parts inspected or replaced, and preservation procedures completed.

Many types of preventative maintenance are scheduled at specific periods or cycles in order to ensure maintenance is timely completed so as to continue optimum operation of equipment. Such cycles include time periods (weeks, months, years), equipment run time (hours, days, number of operations), or queuing events. Supervisors must then either remember or be reminded of these cycles in order to properly schedule preventative maintenance.

The scheduling of periodic maintenance has often been by way of posting assignment sheets in workspaces on bulletin boards or in notebooks. Personnel assigned to conduct preventative maintenance review the workorder, obtain the procedures and data checksheets, complete the maintenance, and route data checksheets to supervisors for review and approval. These data checksheets are then typically filed with previous data checksheets and the supervisor reschedules the preventative maintenance to be completed according to its cycle.

As described above, preventative maintenance systems have typically been manual, and therefore have become administratively burdensome systems. Manual systems limit the effectiveness of facility wide management of scheduling and assignment. Multiple divisions, groups, and sub-groups of personnel require broad dissemination, assignment, and review authority. Immediate supervisors review and analyze the checksheet to ensure operation of systems and equipment for which they are responsible. Supervisors also take care to assign preventative maintenance to most effectively utilize the skills of their personnel. At upper levels of management, on the other hand, personnel are generally less concerned with details of the maintenance and more concerned with the general operation and maintenance of equipment critical to production and efficiency. As such, routing workorder assignments and data sheets to upper levels of management provides relative excess of information and is not on an “as needed” basis. Yet to avoid such excessive information, additional reports are required, which typically summarize maintenance or report only maintenance parameters that exceed certain out of specification tolerances. More specifically, reports are generated listing data “as needed” by a particular manager. As more and more of the reports are generated, the administrative burden of the system increases.

Some methods of automation of preventative maintenance scheduling have been developed to overcome the limitation of these past systems. However, these systems have barely begun to address some of the organizational problems associated with preventative maintenance systems. Typically, these systems simply provide a database of preventative maintenance items, yet they lack features that select or provide only the information required by the particular person. Therefore, these systems have failed to effectively distribute and report preventative maintenance data on an “as needed” basis.

### BRIEF SUMMARY OF THE INVENTION

A method and system of assigning and reporting preventative maintenance workorders are therefore provided to permit a supervisor to store preventative maintenance workorders to a database, to assign the workorder to a person, for persons to report the completion of the workorder, and to automatically notify responsible personnel of data acquired from the preventative maintenance. The workorder comprises scheduling data, equipment data, and a checksheet associated with a required preventative maintenance procedure. The checksheet is used to record and store maintenance data. In one advantageous embodiment, a person records data to the checksheet corresponding to the maintenance data acquired from the preventative maintenance. Subsequently, the completed checksheet is stored in the database. Selected fields of data may include out of specification tolerances whereby certain personnel are automatically notified when the tolerances are exceeded on the checksheet. Additionally, different levels of out of specification tolerances may be identified according to their level of criticality. The level of criticality may be routine out of specification parameters that are easily corrected and do not seriously affect production, while other out of specification parameters may be critical and require notification of additional personnel.

The method and system for assigning and reporting preventative maintenance workorders also includes assigning at least one person to complete the preventative maintenance, and, in one embodiment, a group of persons. When the workorder is assigned to a group, a person from among the group of persons may select to perform the preventative maintenance. When the person selects the workorder, access to the workorder is limited to the one person and the supervisor in order to avoid duplicative efforts by members of the group.

One advantageous embodiment of a method and system for assigning and reporting preventative maintenance workorders includes a computer network interconnecting a central computer, a database for storing preventative maintenance workorders, a supervisor interface, and a technician interface. The computer network typically includes a local area network, a wide area network, or an intranet, which provides interfaces with computer devices, such as a terminal or personal computer. Therefore, the computer devices can be configured to provide the supervisor interface and technician interface. The supervisor interface provides a supervisor with a first electronic mailbox in order to view preventative maintenance workorders and to assign preventative maintenance workorders to at least one technician. The technician interface provides a technician with second electronic mailbox to view preventative maintenance workorders assigned to the technician and to complete the checksheet with the data associated with the preventative maintenance. One advantageous embodiment includes providing electronic mailbox access through an HTML browser, such that additional software, hardware, or firmware is not required on the computer device in order to configure the interface.

In one embodiment, access to each mailbox may be selectively limited by user login identification codes associated with the supervisor and technician, respectively. Other embodiments also include routing the completed checksheets to the supervisor interface for review and approval. Additionally, maintenance data on the checksheet that exceed out of specification tolerances may also be automatically routed to designated personnel.

Another advantageous embodiment of the method and system for assigning and reporting preventative maintenance workorders includes a handheld interface, such as a handheld computer device, for allowing a person to download a copy of the checksheet while performing the maintenance on a system or piece of equipment which is otherwise remote from network computing devices. Therefore, the checksheet and maintenance may be completed remotely and uploaded to the database. One aspect of the method and system also includes prohibiting access to the checksheet in the database after the copy is downloaded. In one embodiment, the handheld interface is a wireless handheld computing device.

The present invention also includes a method of storing a preventative maintenance workorder in a database, the workorder including equipment data, scheduling data, and a checksheet associated with a required maintenance procedure. The method of storing a preventative maintenance workorder includes receiving the equipment data and scheduling data, and constructing the associated checksheet with data cells. Each data cell is associated with a maintenance data parameter from the required maintenance procedure, such as units, parts replacement, a check box, etc. Out of specification tolerances for the maintenance data are identified and personnel that are required to be notified when maintenance data exceeds the out of specification tolerance are likewise identified.

Additionally, the central computer is adapted to use the scheduling data incorporated on the preventative maintenance workorders to automatically reschedule the maintenance according to its cyclic performance requirement. One embodiment also includes checkboxes that provide for scheduling in bulk, such as a plurality of workorders to one person. A graphic icon is also provided to permit scheduling on the supervisor interface to facilitate scheduling a plurality of workorders to at least one person. Other embodiments of a method and system for assigning and reporting preventative maintenance workorders includes providing a search tool for reviewing previous checksheets in order to determine trends and recurrent problems.

Therefore, a method and system for assigning and reporting preventative maintenance workorders is provided such that persons are provided with maintenance data, checksheets, and workorders as required on an “as needed” basis. The method and system limit access to workorders to personnel responsible for the completion of the workorder, such as the supervisor and the technician assigned to complete the workorder. Additionally, the method and system limit the routing of data to personnel upon completion of the workorder. Personnel can individually be selected on an as needed basis to be notified of maintenance data according to levels of out of specification tolerances.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a flowchart illustrating operations performed for assigning and reporting a preventative maintenance workorder according to one embodiment of the present invention;

FIG. 2 is a representational diagram of a system according to one embodiment of the present invention;

FIG. 3 is a flowchart illustrating operations performed for creating a preventative maintenance workorder according to one embodiment of the present invention;

FIGS. 4 and 5 are exemplary displays of a preventative maintenance workorder according to one embodiment of the present invention;

FIGS. 6 through 8 are exemplary displays of an electronic mailbox for viewing a plurality of preventative maintenance workorders according to one embodiment of the present invention;

FIGS. 9 through 11 are exemplary displays for providing the creation of a preventative maintenance workorder according to one embodiment of the present invention;

FIG. 12 is an exemplary display which permits entry of various parameters used to perform a database search of a plurality of preventative maintenance workorder checksheets according to one embodiment of the present invention;

FIG. 13 is an exemplary display which permits scheduling of a preventative maintenance workorder according to one embodiment of the present invention;

FIG. 14 is an exemplary display which permits viewing a list of outstanding preventative maintenance workorders according to one embodiment of the present invention; and

FIG. 15 is an exemplary display which permits viewing a list of overdue preventative maintenance workorders according to one embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

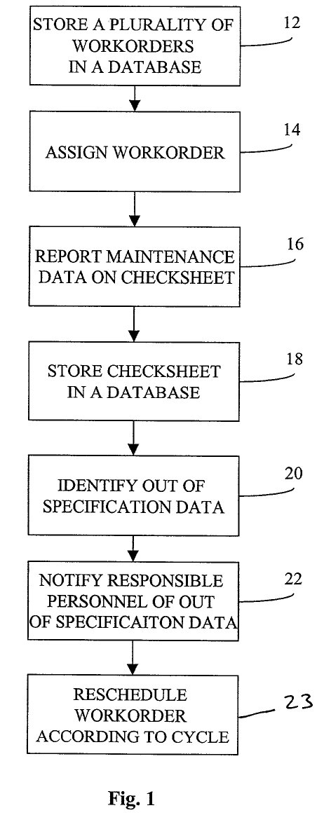

Referring now to FIG. 1, a method and system for assigning and reporting preventative maintenance workorders are illustrated by a flowchart according to one embodiment of the present invention. The preventative maintenance workorders described herein typically relate to maintenance on industrial facilities' systems and equipment. As such, preventative maintenance workorders generally include equipment data specifically identifying the equipment, location, and particular attributes of the equipment. Preventative maintenance workorders also include scheduling data which typically requires periodic rescheduling, such as every month or year, every hundred run hours, etc. A workorder also includes or is accompanied by a checksheet for recording equipment operating parameters and other data obtained or generated from the preventative maintenance. For example, the checksheet often includes data cells for identifying instrument readings, a checkbox to identify that a procedure has been completed, such as lubrication, cleaning, or parts replacement, and other boxes for reporting comments or notes about the maintenance. Also, a procedure for completing preventative maintenance is also typically associated with a workorder and may be included with the workorder or separate therefrom. As known by those skilled in the art, preventative maintenance workorders are generally referred to by the common abbreviation “PM”, which designates not just the preventative maintenance work, but all aspects surrounding the particular preventative maintenance including any supporting documentation, equipment data, scheduling data, checksheets, maintenance procedures, the assignment of the work, completion of the work, etc. The term workorder itself is sometimes more narrowly used to refer to the assignment of work, for example the assignment may be referred to as an “open workorder on a PM.” As more narrowly used, this nomenclature does not necessarily limit the description of workorder herein, but rather assigned workorders are specifically referred to herein as assigned, released, or open, as will be subsequently discussed. As such, the term workorder used herein is interchangeable with the general term PM.

According to one embodiment of a method and system for assigning and reporting preventative maintenance workorders as illustrated in FIG. 1, a plurality of workorders are stored in a database, such as a database generally associated with a computer system. See block 12. Prior to an upcoming due date for the workorder to be completed, a person responsible for assigning the workorder, assigns the workorder to a technician from the database. See block 14. As such, the workorder is then provided to the technician who completes the preventative maintenance in accordance with a particular procedure. The technician generally obtains maintenance data as a result of the procedure and then reports maintenance data on the checksheet. See block 26. Generally, the technician accesses the checksheet from the computer database and records the data directly to the database.

After the completed checksheet is recorded in the database, any maintenance data parameters that exceed out of specification tolerances are identified, generally in an automatic and electronic manner. See block 20. One or more responsible personnel are predetermined to receive notification of the maintenance data that exceeds the out of specification tolerance. See block 22. The responsible personnel may be generally identified according to their own specific needs for knowing the data. For example, immediately responsible personnel are more concerned with the daily operation and specifics of maintenance data and may desire to be notified of any or all out of specification tolerance data generally associated with the maintenance workorder procedure. Alternatively, upper level management personnel are less concerned with the day to day workings of certain equipment and systems and are rather more concerned with the overall production and efficiency of the system and equipment. Consequently, only data which seriously effects the production and efficiency of general facility systems may require notifying upper level management personnel. Therefore, these personnel may be identified according to different levels of out of specification tolerances, referred to herein as levels of criticality. In one example, two levels of criticality are identified, “routine” and “critical,” corresponding to notification of immediately responsible personnel and upper level management, respectively. In other situations, additional levels of criticality may be established, if so desired.

As discussed above, out of specification tolerance data need not be maintenance data that is generally identified by the manufacturers of equipment as being out of specification operating parameters, but rather include many general forms of data such as replacement of expensive parts, excessive run time hours compared to normal operation, or data achieved from diagnostic tests that may necessarily indicate potential problems with equipment or systems. Therefore, according to this embodiment of a system and method for assigning and reporting preventative maintenance workorders, several levels of criticality may be identified according to the needs and requirements for reporting maintenance data to individual personnel on an “as needed” basis. Other such systems of notification of personnel of out of specification tolerance data will become apparent to one skilled in the art in order to meet the needs of specific equipment and system reporting criteria.

In many cases, immediate supervisors may be required to review an entire checksheet for approval, regardless of out of specification tolerances. Preventative maintenance workorders with this requirement are flagged for such routing, which is accomplished in the same manner described above. In fact, workorders requiring additional routing, either before or after assignment and completion, may be provided similar routing criteria, as needed.

Preventative maintenance workorders are generally completed in cycles, for example, weekly, monthly, quarterly, semi-annually, etc. As such, it is also desirable to reschedule a workorder to a new due date according to the periodicity of the cycle. Therefore, one embodiment of the present invention also includes automatically rescheduling the workorder after completion according to the prior scheduled date. See block 23. Alternative scheduling cycles include run hours, production quotas, or other queuing events, and the method and system may be adapted to automatically reschedule a workorder based upon known periods or estimates of these cycles. Rescheduling may likewise be accomplished manually by the supervisor. As such, the workorder is automatically routed back to the supervisor and then the next due date is recorded in the database by the supervisor.

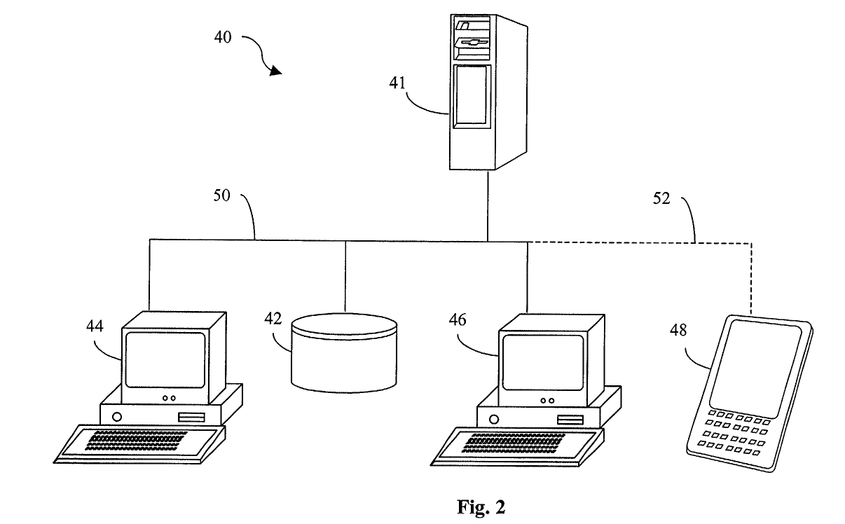

Referring now to FIG. 2, one advantageous embodiment of the method is implemented and developed via a computer system 40 including a central computer 41 or other computer device wherein the central computer is part of a larger computer network 50 such as, for example, a local area network, a wide area network, or an intranet. The computer network 50 typically interconnects additional computing devices 44, 46, 48 that facilitate interface with the implemented system and are used by, among others, the technician and the supervisor. The interfaces 44, 46, 48 generally include desktop personal computers, laptop personal computers or other portable computing devices, while the central computer 41 may comprise, for example, a desktop personal computer, a laptop personal computer, a server, a mainframe computer, or like devices or combinations thereof capable of implementing functions and methods described herein which are known to those skilled in the art. As such, FIG. 2 illustrates one embodiment of a system 40 for assigning and reporting preventative maintenance incident reports. According to this embodiment, a supervisor interface 44 and a technician interface 46 are both provided for accessing a database 42 by way of a computer network 50 and a central computer 41. The database 42 stores a plurality of preventative maintenance workorders.

By way of example, the supervisor accesses an electronic mailbox via the supervisor interface 44. The electronic mailbox provides the supervisor with a preventative maintenance workorder in advance of its due date for assignment to a technician. As described below, the central computer 41 typically automatically provides the supervisor interface the preventative maintenance workorder via the respective electronic mailbox based upon a due date that has been previously assigned to the workorder and the anticipated time for completion of the workorder to thereby insure completion of the workorder by the due date. Upon assigning the maintenance workorder, the technician would likewise receive the workorder in an electronic mailbox associated with the technician interface 46. Any maintenance procedures or other documentation associated with the maintenance workorder may likewise be accessible through the technician interface 46. As such, the technician may advantageously retrieve all necessary information, checksheets, equipment data, and procedures associated with the workorder through the technician interface 46. Upon completion of the maintenance workorder and after obtaining the necessary maintenance data, the technician records the maintenance data on the associated checksheet via the technician interface 46. Typically, the checksheet may comprise a matrix of rows and columns of data cells. One data cell identifies the maintenance data while a corresponding data cell provides a space to record the maintenance data. Upon recording the maintenance data to data cells on the checksheet, all completed checksheets are then stored in the database 42 according to their particular preventative maintenance workorder.

Any data on the checksheet that exceeds an out of specification tolerance may be identified by the central computer 41, which serves as the automatic and electronic manner of identification and notification referenced above. Particular data cells may be identified by certain parameters corresponding to a data cell. For example, the measurement of motor current is typically expressed in amperes and may be a measurement resulting from a diagnostic test. As such, if a particular motor current exceeds a particular amperage and that value is recorded in the respective data cell, the central computer 41 is adapted to automatically recognize that the data in the respective data cell exceeds the out of specification tolerance. Upon data being identified as exceeding an out of specification tolerance, the central computer 41 is adapted to automatically send a notification to the electronic mailbox of the required personnel, as needed. It is necessary to note, however, that “exceeding” an out of specification tolerance does not necessarily refer to units greater than a range, as described in the motor current example. For example, bearing measurements typically “exceed” specification when they are less than minimum diameter tolerances, or replacement of parts that are not normally replaced may be deemed to “exceed” tolerance. Many other such examples of “exceeding” out of specification tolerances will come to mind as the method and system for assigning and reporting preventative maintenance workorders is implemented through a broad range of facilities systems and equipment.

FIG. 2 also illustrates another advantageous embodiment of the present invention that includes an interface comprising a portable handheld computing device 48, such as a personal data assistant (PDA) or the like. This embodiment advantageously provides a technician with the maintenance data checksheet at a remote location, such as where the equipment or systems are located. Thus, maintenance data may be recorded contemporaneous to performance of the preventative maintenance procedure, rather than recording it on paper and later entering the data via hardwired technician interface 46 remote from the equipment or system. Communication by the computer network 52 with the handheld device 48 may not be continuous, and, as such, the handheld 48 must download a copy of the checksheet from the database to the wireless handheld device to complete the maintenance remotely. Since the technician is not completing the maintenance data checksheet directly to the database 42, the database 42 flags the downloaded checksheet such that other personnel may not access and record data on the checksheet until the downloaded copy has been uploaded as a completed checksheet. Therefore, this prevents duplicative efforts of completing preventative maintenance procedures and recording associated maintenance data by other technicians.

The portable handheld computing device 48 may communicate with the computer network via specialized communications hardware, such as a docking station generally compatible with a particular PDA and supplied by PDA manufacturers. Such docking stations interface with a computer or other computing device directly connected to the computer network and are known to those skilled in the art. In one advantageous embodiment the portable handheld computing device 48 interfaces with the computer network 50 via a wireless connection 52 to the computer network. In this particular embodiment, the computer network 50 includes a wireless connection 52 such as infrared, radio frequency, or other wireless communication techniques known to those skilled in the art. As such, the handheld computing device 48 is in communication with the central computer 41 via the wireless portion 52 of the network, and such communication may either be continuous or periodic. The wireless communication 52 may be the sole means of communication by the handheld computing device 48 with the computer network 50, or in addition to other means such as the docking station previously described.

Login identification codes may be associated with one or more of the user interfaces 44, 46, 48. Many computer networks commonly restrict access to the computer network by assigning login identification codes to each authorized user. Each user then provides a particular login identification code to a respective computer network in order to be granted access, generally via a respective interface. More specifically, these login identification codes not only provide access, but also allow a computer network to define particular individualized parameters related to each person's access. As such, the central computer 41 may be configured to allow only particular login identification codes and consequently only particular users access to the supervisor interface 44 or the technician interface 46. Thus, the login identification code limits access to each interface 44, 46, 48 according to the particular user. As such, certain personnel are selected and known by the computer network according to their login identification codes such that access may be provided to these personnel via a respective interface 44, 46, 48. Moreover, different personnel may be permitted to access different ones of the interfaces by defining the permissible login identification codes separately for each user interface 44, 46, 48.

Another advantageous embodiment of the present invention also uses the login identification codes to restrict access to preventative maintenance workorders as required to be viewed by responsible personnel. For example, the central computer 41 may restrict access to preventative maintenance workorders according to the equipment data found in the workorder such as the division or supervisory personnel that have been defined in advance to be responsible for assuring that the preventative maintenance is completed. Typically, the preventative maintenance workorder may be provided to the electronic mailbox associated with the supervisor interface 44 according to the login identification code. Subsequently, the supervisor, via the supervisor interface, assigns each preventative workorder to a particular technician to be accessed via the technician interface 44. As described above, each of the above interfaces 44, 46, 48 generally provide review of the preventative maintenance workorder, however, additional duties such as scheduling or completion of the preventative maintenance checksheet and associated data may be limited to certain personnel according to their respective login identification codes. Likewise, personnel required to be notified of maintenance data exceeding out of specification tolerances may be identified by the central computer 41 based upon a predetermined listing of personnel to be notified of different out of specification tolerances for respective pieces of equipment with such notification being provided according to their particular login identification code.

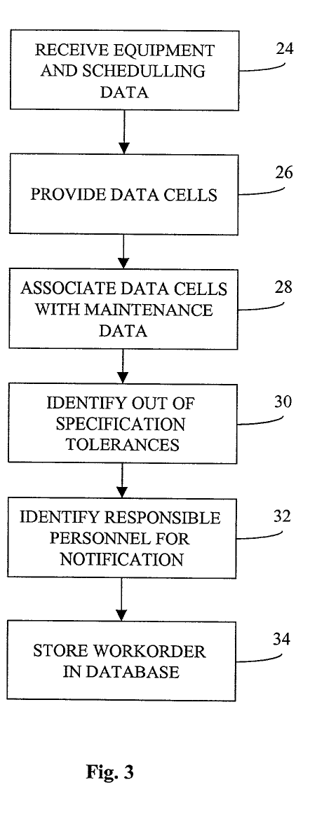

Referring now to FIG. 3, one advantageous embodiment of a method and system for assigning and reporting preventative maintenance workorders includes a method of recording a new preventative maintenance workorder in a database for scheduling and future assignment. This method is required to set up and establish the plurality of workorders to be stored in the database for reporting and assigning, as described above. Additionally, new workorders are typically required upon installation of new equipment and systems or upon identification of new techniques for protecting and maintaining equipment and systems. As such, equipment data and scheduling data is first received and recorded. See block 24. Equipment data may include identification of the equipment, location of the equipment, a division or group of personnel generally responsible for the equipment, and other existing preventative maintenance procedures and workorders for the equipment. Scheduling data for the equipment may also include the periodic intervals for assigning a particular maintenance procedure and the next scheduling due date for the particular procedure. See block 24. The new checksheet is created beginning with data cells. Individual data cells will be used for identifying data normally associated with the checksheet from a preventative maintenance work procedure. See block 26. As such, these may include operating parameters of the equipment, replacement of parts, completion of critical steps of a work procedure, etc. Certain maintenance data will be identified by units of measurement. For example, preventative maintenance data might include measurement of motor current such that the maintenance data would be given in amperes. See block 28. Therefore, amperes would be associated with the particular data cell on a checksheet. Additionally, at lease some data cells may be identified with out of specification tolerance criteria. See block 30. For example, with respect to a motor current, a certain maximum amperage may be considered out of specification and thus affecting the operation of the equipment. As such, the data cell will be processed in order to flag the out of specification tolerance data. Likewise, personnel responsible for being notified for the out of specification data may be associated with each data cell, and the data cell will be processed in order to notify responsible personnel of the data exceeding an out of specification tolerance.

As described above, one or more levels of criticality of out of specification tolerance data may be assigned for each individual data cell. In keeping with the above motor example, a maximum motor current may be identified as out of specification tolerance and perhaps requires cleaning of the motor and thus requiring only a few personnel to be notified of the out of specification according to a routine level of criticality. Alternatively, a larger maximum current may indicate imminent failure of the motor and thus requires notification of additional personnel according to a critical level of criticality. Many additional manners of notification according to various levels of criticality will become apparent to one skilled in the art as the method and system of the present invention is implemented among a broad variety of facilities' systems and equipment.

After providing the foregoing data to create a new workorder, the new workorder is stored in a database. See block 34. According to this embodiment, these steps may be repeated for a plurality of workorders. Additionally, it is often advantageous to schedule a block of preventative maintenance workorders coincident to each other. For example when an electric motor is shut down for preventative maintenance, it is often more efficient to perform preventative maintenance on the associated mechanical machinery rather than shutting down both the electric motor and the mechanical machinery at different times to perform maintenance on only one piece of equipment. Therefore, one embodiment of a method and system for assigning and reporting preventative maintenance workorders includes an option to schedule related preventative maintenance at coincident periods, also referred to as “block” scheduling. As such, the central computer is configured to automatically schedule designated preventative maintenance workorders in block. Accordingly, when any one of the designated workorders in a block is rescheduled, the system automatically reschedules each additional designated workorder in that block. Other types of preventative maintenance also require block scheduling, such as scheduling at periods of lower production, nearer times of facilities inspections or reviews, and at many other times, which will become apparent to those skilled in the art.

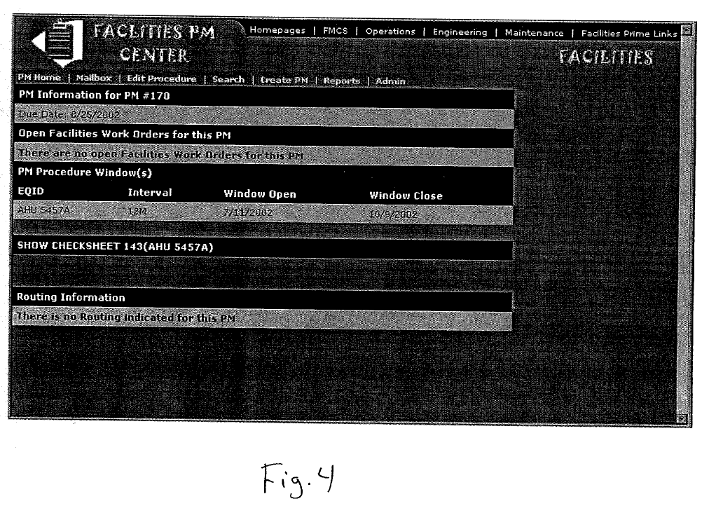

Turning now to one exemplary embodiment of a method and system for assigning and reporting preventative maintenance workorders, personal computers include software for facilitating the user interface such as database access programs, electronic mail programs, and hypertext markup language (HTML) document browsing programs. Additionally, the computer network facilitates the storing and controlling of information in computer databases which are commonly accessed at the personal computer user interfaces. One embodiment of the present invention comprises providing the electronic mailboxes via an HTML browser such that no additional software, firmware, or hardware is required to adapt each interface to a particular electronic mailbox. This is most readily accomplished via HTML applications that integrate electronic mail applications and are known to those skilled in the art. Accordingly, FIGS. 4 through 12 illustrate the various displays represented via the user interfaces, and, as described below, are generally defined by HTML documents. However, the method and system for assigning and reporting preventative maintenance incident reports can be employed in conjunction with other electronic database systems or computer software systems without departing from the spirit or scope of the present invention.

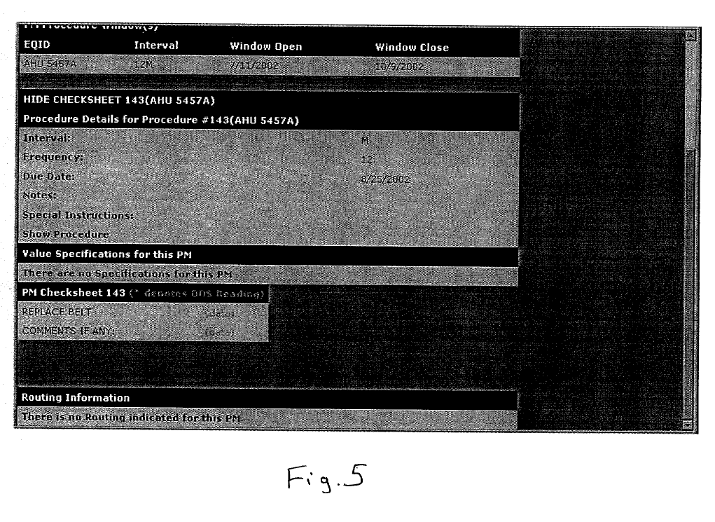

By way of example, FIGS. 4 and 5 illustrate a preventative maintenance workorder. The top line illustrates the preventative maintenance number, the due date for the next preventative maintenance and the status of open (i.e. assigned) workorders for this preventative maintenance workorder. Equipment data includes the equipment ID shown as AHU5457A to occur at a 12 month interval with the next preventative maintenance window between Jul. 11, 2002 and Oct. 9, 2002. Below the equipment data and scheduling data identifiers is a hypertext link to the checksheet, which is shown open on FIG. 5. In this example, the checksheet also shows scheduling data and a hypertext link to the procedure. The data cells of the checksheet include belt replacement and comments with a data field for each respective maintenance data. Additionally, if any out of specification tolerance parameters were included in this checksheet, they would appear under “Value Specifications for this PM” and the checksheet below would include a data field relating to that out of specification data tolerance. The bottom line on FIGS. 4 and 5 includes routing information which could include information necessary for routing the preventative maintenance workorders to the supervisor for assignment, to the technician for completion of the checksheets, to the supervisor upon completion of the checksheet, and to responsible personnel requiring notification of maintenance data exceeding out of specification tolerances. Additionally, the workorder may include hypertext links to other workorders that are outstanding on the same piece of equipment and block scheduled workorders may include hypertext links between other workorders in the block. Therefore, supervisors and technicians may review concurrent workorders in order to deconflict and organize maintenance between related preventative maintenance procedures.

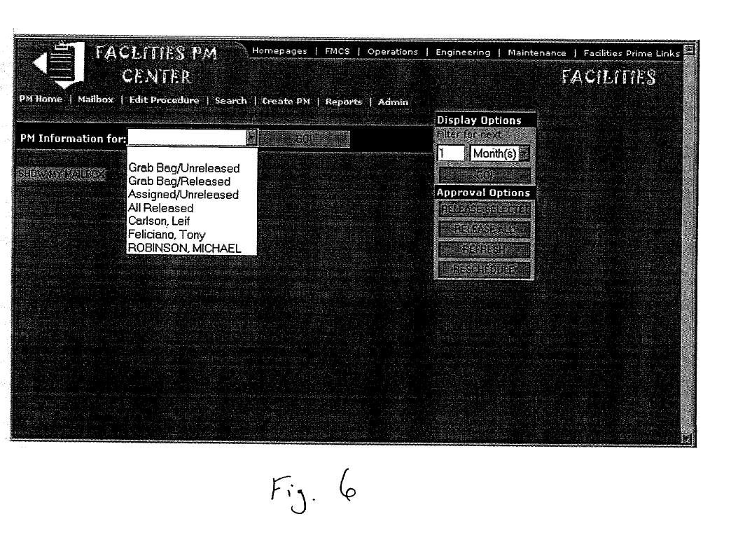

FIGS. 6, 7, and 8 are an example of an electronic mailbox shown on the supervisor interface 44. The supervisor may display the workorders according to a desired filter into the future, such as one month as illustrated in this example. From the mailbox, the supervisor assigns and releases the workorder. “Assign” refers to the designation of at least one person to complete the preventative maintenance. “Release” refers to the publication of the workorder to the assigned person. Generally, the technician assigned to complete the workorder will have a similar mailbox, but the assigned workorder will not be available for display in the technician's mailbox until the supervisor has also released the workorder. The method provides a valuable scheduling tool for the supervisor to assign a workorder far in advance for planning purposes. As such, the workorder may be reassigned to another technician prior to release, and the process appears seamless to the technicians with only the technician to which the workorder is reassigned ever being notified, thereby avoiding confusion and/or duplication of efforts.

As shown in FIG. 6, the supervisor may select to list preventative maintenance workorders according to all assigned, all released, those assigned to particular people, or those assigned to “grab bag.” With respect to those assigned to “grab bag,” grab bag includes a plurality of personnel assigned to complete a preventative maintenance workorder from among whom any one person may select the preventative workorder to complete. At that time, the preventative workorder is removed from grab bag and assigned to the person whom has selected to complete it. As such, this provides an advantageous method to schedule assets of a large group of people who are involved in preventative maintenance. Additionally, the display options box on the right-hand side provides the supervisor the opportunity to view preventative maintenance workorders coming due for a specified period of time into the future. Below the display options box is the approval options box and includes release buttons.

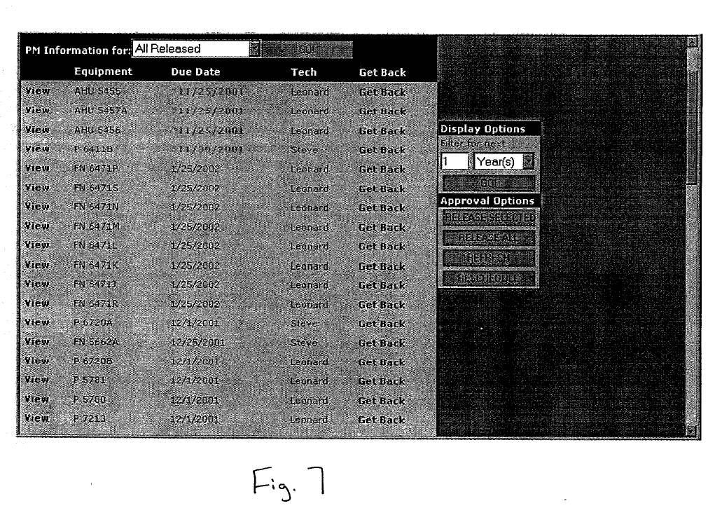

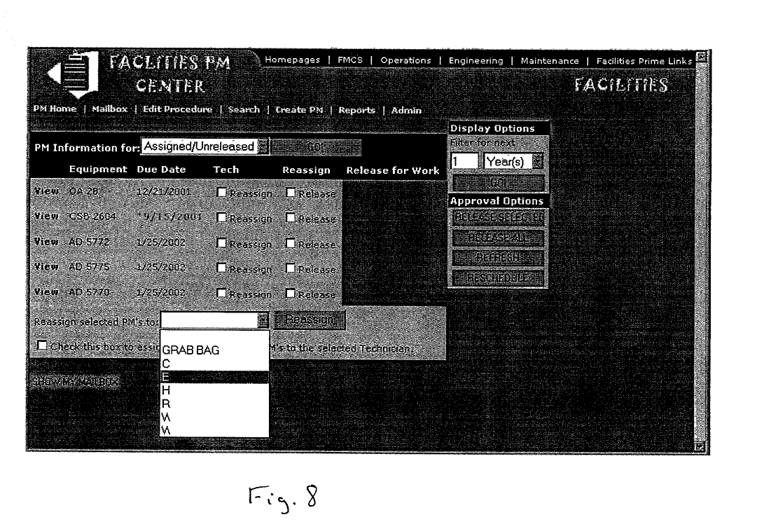

Referring specifically to FIG. 7, all released workorders are listed including the equipment, the due date, the technician assigned to complete the workorder. Any overdue workorders are highlighted, such as providing them in a different color or with an asterisk beside the due date, as shown. Also included are hypertext links to view the entire workorder on the far left-hand column and in the far right-hand column a hypertext link labeled “get back.” “Get back” permits a supervisor to retrieve a released workorder such that it may be reassigned. FIG. 8 illustrates a list of those workorders that have been assigned yet unreleased by the supervisor. The list includes a hypertext link to view the workorder, the equipment identifier, the due date for the workorder and check boxes to either reassign the workorder or release the workorder to the technician. As such, multiple check boxes may be selected in order to reassign selected workorders in bulk to particular technicians, as selected from the reassign box at the bottom of the list.

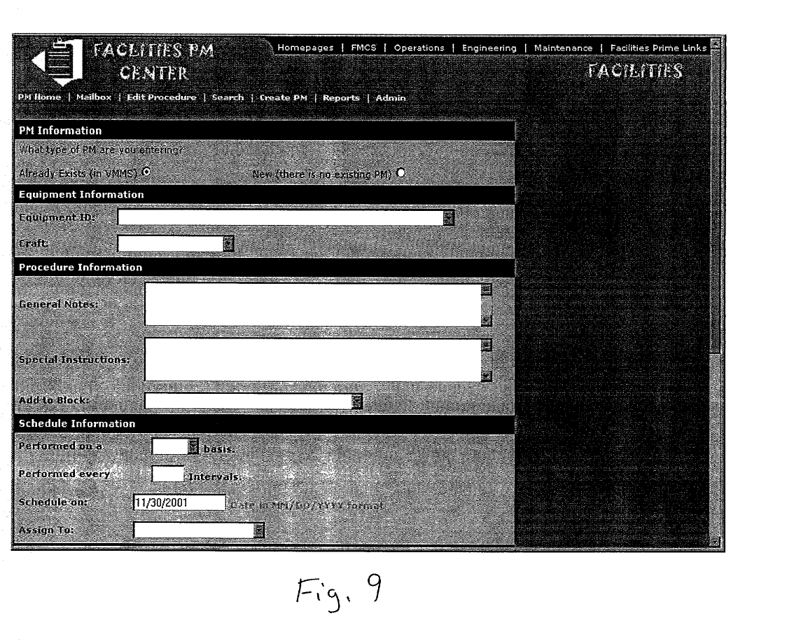

Referring now to FIGS. 9, 10, and 11, an interface for creating a preventative maintenance workorder is illustrated. The creation page, according to FIG. 9, includes entering equipment identification and craft. Equipment identification and craft may each be selected from a pull-down menu which has stored in it a plurality of equipment or systems within the facility. “Craft” is a designation of particular personnel responsible for completing types of maintenance, and examples of “craft” include electricians, mechanics, electronics technicians, HVAC technicians, etc. Craft information thus provides the supervisor with necessary information to assign appropriate technicians to complete a preventative maintenance workorder. Additionally, procedure information may be added in the creation page as demonstrated on FIG. 9. Scheduling data is also entered to include the periodicity of scheduling and the first expected scheduling date. The scheduling data also designates the supervisor who is responsible for assigning the preventative maintenance to technicians in the “Assign to” block. As such, the supervisor of a particular division or group will view only those workorders which the supervisor is to assign, so as to limit workorders in the supervisor's mailbox to those requiring the supervisor's attention.

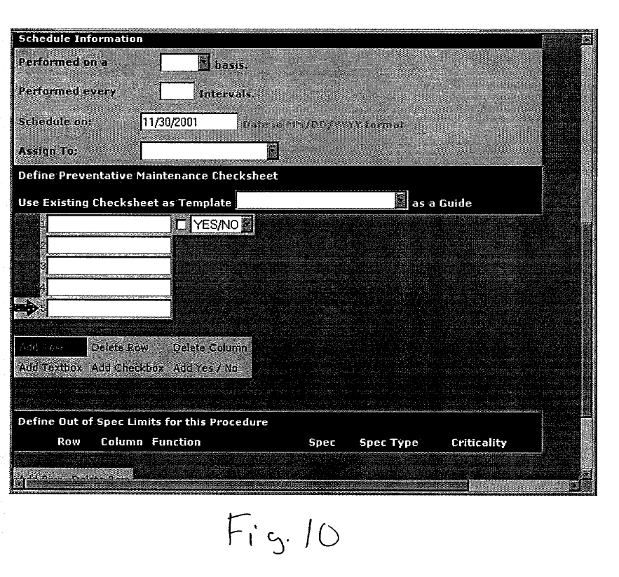

FIG. 10 additionally illustrates the data cells used to construct a checksheet for the preventative maintenance workorder. One advantageous embodiment includes using preexisting checksheets as a template for creating the checksheet for the present workorder. As such, equipment which routinely uses similar checksheets for different preventative maintenance workorders may be modified in order to provide consistency between checksheets. Data cells are indicated at lines 1 through 5. Next to data cell 1, a check box and a “YES/NO” box have been added. Either may be used to record maintenance data, for example, whether or not a part has been replaced. Below the data cells are found options to add additional rows of columns, to delete columns if additional columns have been added, add a text box for comments, adding check boxes, or adding a “YES/NO” box. Other such data cells and associated types of data entry will become apparent to those skilled in the art as the present method and system is implemented among different facilities, departments, and divisions.

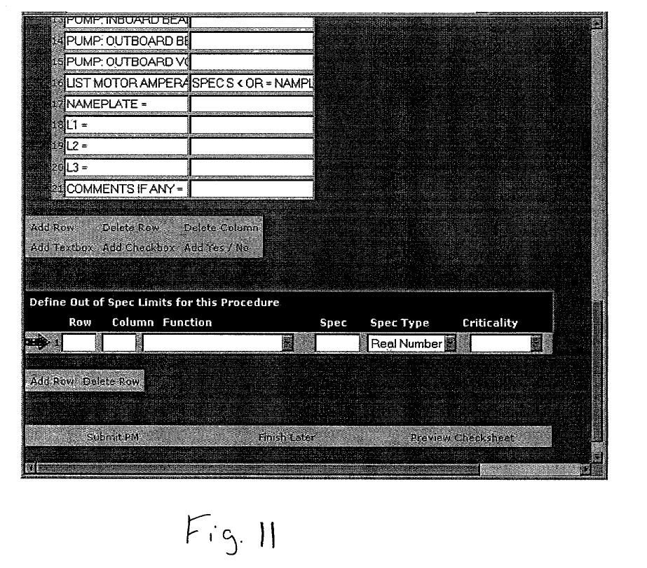

As can be seen on FIG. 11, the completed construction of the checksheet includes one or more data cells arranged in rows and columns, the first column in a row illustrating the type of maintenance data, the second column providing a cell in which the data corresponding to the first column is recorded. For example, row 16 lists motor amperage in the first column, and the second column provides a data cell in which to enter the amperage of a motor associated with the diagnostic test run during the preventative maintenance.

Finally, as illustrated at the bottom of FIG. 11, out of specification tolerances for designated rows and columns may be chosen. By way of example, row 16, column 2 lists motor amperage and an out of specification tolerance may be identified by a maximum amperage. The level of criticality may also be chosen corresponding to the person or number of personnel that must be notified according to each out of specification tolerance parameter. The option to add additional rows is included and additional rows may be included for any of the rows and columns corresponding to data cells.

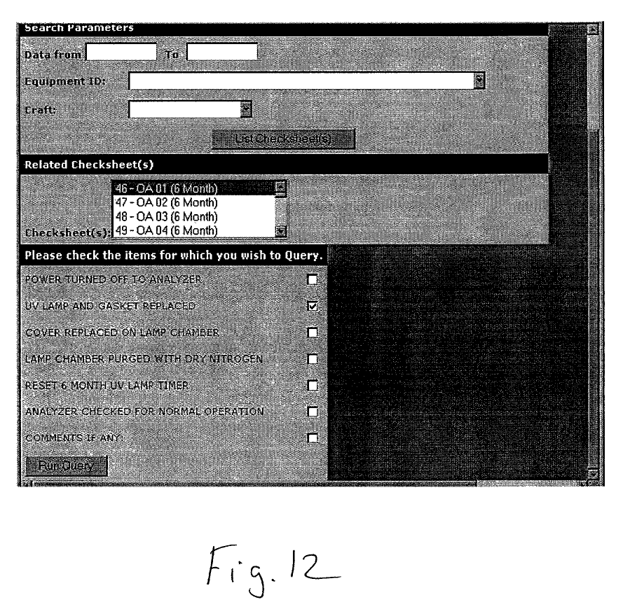

Referring now to FIG. 12, another advantageous embodiment of a method and system for assigning and reporting preventative maintenance workorders includes the ability to search completed checksheets in the database for a particular preventative maintenance item. Search parameters may be entered in order to search checksheets according to common dates, a single piece of equipment, or a designated craft of technicians. Individual checksheets relating to a single preventative maintenance may be searched, and, in this example, a menu of checksheets has been scrolled through to checksheet “46-0A 01.” The data identified in checksheet No. 46 is included at the bottom of the page and all the checksheets completed for this preventative maintenance and stored in the database may be queried all at once such that all or selected portions of data from that checksheet may be compared with previous checksheets. For example, next to “UV Lamp and Gasket Replaced” the box has been checked and therefore the query will return all of the previous checksheets that have included replacing the UV lamp and gasket.

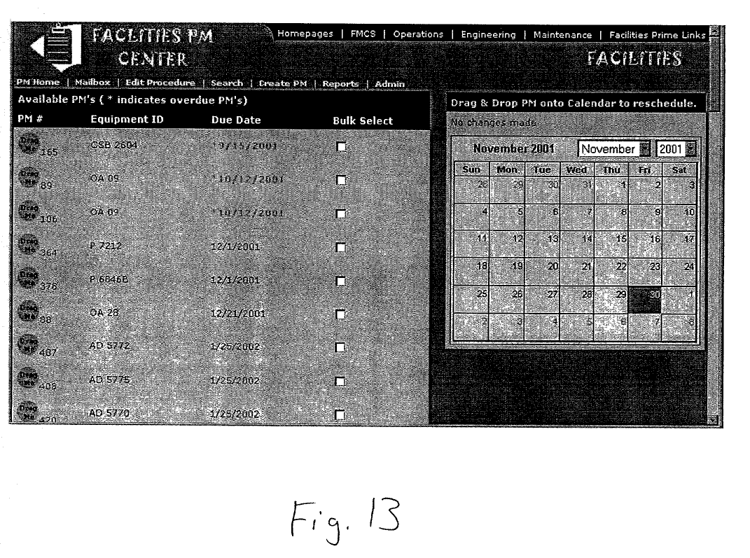

FIG. 13 illustrates another advantageous page for scheduling preventative maintenance workorders. It includes a list of available preventative maintenance workorders and their respective due dates. The due dates may be rescheduled according to the needs of the supervisor. One method to accomplish rescheduling includes selecting the “drag me” icon in the far left column, and dragging the icon to a respective date on the graphic calendar. This is typically implemented by means of a graphic user interface, such as a mouse or the like. Alternatively, a plurality of preventative maintenance workorders may be rescheduled by selecting check boxes in the right hand column, or selecting all of the check boxes with the “bulk select” icon.

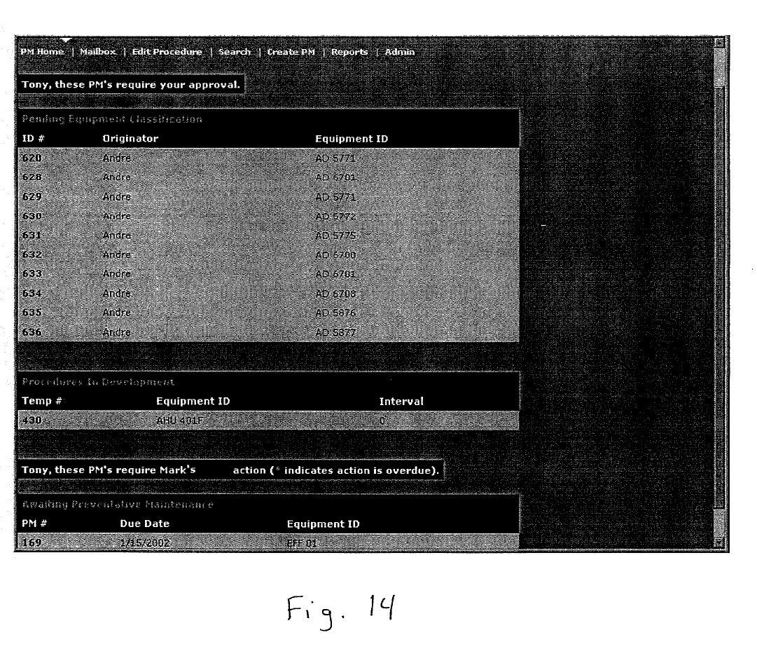

FIG. 14 illustrates another advantageous feature displaying a supervisor mailbox including preventative maintenance workorders awaiting approval by the supervisor, and those that are awaiting action by assigned technicians. As such, the particular display is uniquely defined for a particular supervisor according to the login identification code. Outstanding preventative maintenance assignments can easily be tracked by their status through this display. For example, it is often necessary to route completed workorders and checksheets, regardless of whether maintenance data exceeds out of specification tolerances, to immediate supervisors for approval prior to rescheduling the workorder. Therefore, these completed workorders are presented under a corresponding header, such as PMs requiring approval displayed at the top of FIG. 14. Also, additional headers and sub-headers may be included for the supervisor as desired to organize and list outstanding preventative maintenance workorders, such as “awaiting preventative maintenance” displayed at the bottom of FIG. 14. Other such headers for organizing workorders will become apparent to those skilled in the art as the present method and system is implemented among different facilities, departments, and divisions.

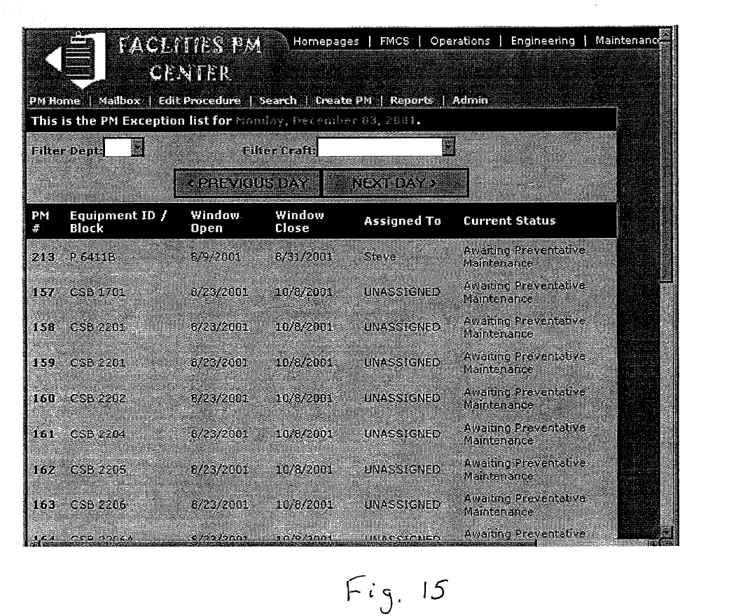

Overdue preventative maintenance workorders are of particular concern, not only to responsible supervisors, but to additional facilities personnel. As such, it is advantageous to provide a list of preventative maintenance workorders that are overdue on a particular day so that they receive the necessary attention to be completed in a timely manner. One such list is displayed in FIG. 15 and permits viewing any overdue workorders, referred to as PMs in exception. An additional feature provides a filter such that the list only includes overdue workorders for a particular department or craft. Such a filter advantageously avoids excessive information and provides a limit to view only parts of the list as needed by particular personnel. Other such filters to limit excess of information will become apparent to those skilled in the art as the present method and system is implemented among different facilities, departments, and divisions.

One embodiment of the supervisor interface includes an automatic electronic notification of overdue workorders. This notification may be accomplished via electronic mail or other notification methods associated with a computer network. Additionally, it is advantageous to provide automatic notification of “grab bag” workorders approaching due dates and that have yet to be selected by a member of the assigned group. For example, a predetermined amount of time prior to the due date, such as one day, the supervisor may receive notification of the unselected grab bag workorder and choose to reassign or reschedule the workorder to ensure proper completion. As such, it is advantageous to provide a link, generally within the automatic notification, to a reassignment page or a rescheduling page for each workorder that is either overdue or approaching an overdue date.

The foregoing exemplary displays illustrate a few of the possible embodiments of displays according to one embodiment of a method and system for assigning and reporting preventative maintenance workorders. Typically, any of the foregoing displays may be available at either the supervisor interface 44 mailbox, the technician interface 46 mailbox, or any other defined interface mailboxes as will be required for various implementations of the present invention. Additionally, each display may be uniquely defined for each interface and mailbox, and in turn, for each particular user of the interface, by respective login identification codes. Uniquely defined mailboxes will permit organizing and displaying only those preventative maintenance workorders that require attention by a particular person. Thus, personalization of displays for each mailbox effectively avoids an excess of information and permits dissemination of preventative maintenance workorders and maintenance data on an “as needed” basis. The form and requirements of each display will be directed by the needs of each circumstance and person, and therefore adaptations, modifications, and alternative embodiments of each mailbox will become apparent to those skilled in the art.

Therefore, several embodiments of a method and system for assigning and importing preventative maintenance workorders have been provided. As such, the embodiments of the present invention permit improved notification of completed checksheets to responsible personnel. More specifically, maintenance data exceeding out of specification tolerances are provided to selected personnel on an “as needed” basis without adding administrative burdens to the system.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of assigning and reporting a plurality of preventive maintenance workorders, a workorder including equipment data, scheduling data, and a checksheet associated with a required maintenance procedure, the method comprising:
storing a plurality of preventative maintenance workorders in a database;
assigning at least one workorder to at least one person;
reporting maintenance data on the checksheet by the assigned at least one person;
storing the checksheet including maintenance data in the database;
automatically identifying maintenance data exceeding an out of specification tolerance from the maintenance data reported on the checksheet; and
automatically notifying responsible personnel of the maintenance data exceeding the out of specification tolerance.

2. The method according to claim 1, wherein the step of identifying the out of specification tolerance includes identifying a level of criticality of the maintenance data exceeding the out of specification tolerance and identifying the responsible personnel based on the level of criticality.

3. The method according to claim 2, further comprising downloading the checksheet to a handheld wireless interface for reporting the maintenance data on the downloaded checksheet and subsequently uploading and storing maintenance data to the database.

4. The method according to claim 3, further comprising prohibiting access to the checksheet in the database until after the step of storing the maintenance data on the checksheet to the database.

5. The method according to claim 1, further comprising selectively limiting access to the workorders in the database to designated personnel, the designated personnel being identified by a login identification code.

6. The method according to claim 5, further comprising
providing a plurality of electronic mailboxes, each mailbox corresponding to a login identification code; and
automatically routing the workorder to the electronic mailbox of a designated supervisor for assigning to the at least one person prior to a predetermined due date.

7. The method according to claim 6, further comprising automatically routing the assigned workorder to the electronic mailbox of the assigned person.

8. The method according to claim 7, further comprising automatically routing the workorder to the electronic mailbox of the supervisor upon completion of the checksheet.

9. The method according to claim 8, further comprising automatically rescheduling a periodically recurring workorder to a due date according to a predefined periodicity upon completion of the workorder.

10. The method according to claim 5, further comprising:
releasing the assigned workorder;
selectively limiting access to the workorder to the supervisor prior to release; and
selectively limiting access to the workorder to the supervisor and the assigned person after release.

11. The method according to claim 10, wherein assigning comprises assigning a workorder to a group and permitting selection of the workorder by a member of the group, wherein the reporting and storing steps are performed by the member of the group selecting the workorder, and the method further comprising selectively limiting access to the workorder to the supervisor and the one person.

12. A method of storing a preventative maintenance workorder in a database, a workorder including equipment data, scheduling data, and a checksheet associated with a required maintenance procedure, the method comprising:
receiving the equipment data and the scheduling data;
providing data cells for construction of the checksheet;
associating each data cell of the checksheet with a respective type of maintenance data;
identifying an out of specification tolerance for the maintenance data parameter;
identifying at least one responsible person for notification of maintenance data exceeding out of specification tolerance; and
storing the equipment data, the scheduling data, the checksheet, and the at least one responsible person in the database.

13. A method according to claim 12, further comprising identifying a second out of specification tolerance for the same maintenance data parameter, each out of specification tolerance being identified according to a respective level of criticality.

14. A method according to claim 13, further comprising identifying at least one responsible person for notification of maintenance data exceeding the second out of specification tolerance.

15. A system for assigning and reporting a plurality of preventative maintenance workorders, a workorder including equipment data, scheduling data, and a checksheet associated with a required maintenance procedure, the system comprising:
a central computer;
a database in communication with said central computer for storing preventative maintenance workorders;
a supervisor interface including a first electronic mailbox adapted to view the preventative maintenance workorders, assign the preventative maintenance workorders to at least one technician, and release the workorder to the at least one technician;
a technician interface including a second electronic mailbox adapted to view a released workorder assigned to the respective technician, complete the checksheet by inserting maintenance data to the checksheet, and store the completed checksheet in the database; and
a computer network interconnecting the central computer, the technician interface, and the supervisor interface.

16. A system according to claim 15, wherein the supervisor interface and technician interface each comprise a respective computer device including a display device and an input device.

17. A system according to claim 16, wherein first and second electronic mailboxes are only accessible by entry of respective login identification codes.

18. A system according to claim 17, wherein the computer network is selected from the group consisting of a local area network, wide area network or intranet.

19. A system according to claim 18, wherein the computer devices are adapted to access the first and second electronic mailboxes via an HTML browser.

20. A system according to claim 19, wherein the technician interface comprises a portable handheld computer device adapted to download a copy of the checksheet, complete the checksheet copy, and upload the completed checksheet copy to store the checksheet in the database.

21. A system according to claim 20, wherein the portable handheld computer comprises a wireless computing device capable of communicating with the computer network via a wireless communication connection.

22. A system according to claim 20, wherein the central computer is adapted to prohibit access to the checksheet in the database after the copy of the checksheet is downloaded and before the completed checksheet is uploaded and stored to the database.

23. A system according to claim 18, wherein the central computer is adapted to automatically route the completed checksheet to the first electronic mailbox of the supervisor interface.

24. A system according to claim 23, wherein the central computer is adapted to automatically route maintenance data exceeding an out of specification tolerance to designated personnel.

25. A system according to claim 24, wherein the central computer is adapted to automatically route the maintenance data exceeding the out of specification tolerance to personnel according to a predetermined criticality of the out of specification parameter.

26. A system according to claim 18, wherein the electronic mailbox of the supervisor interface is adapted to provide an icon corresponding to a workorder and to provide a graphic calendar such that the icon is positionable over a date on the calendar for scheduling maintenance activities in accordance with the workorder on that date.

27. A system according to claim 18, wherein the electronic mailbox of the supervisor interface is adapted to provide a checkbox corresponding to each of the plurality of workorders and a plurality of checkboxes are selectable in order to assign all of the selected workorders to at least one person.
